(19) United States
(12) Patent Application Publication
(10) Pub. No.: US 2012/0192651 A1
(43) Pub. Date: Aug. 2, 2012

(54) MULTI PROBE UNIT FOR ULTRASONIC FLAW DETECTION APPARATUS

(75) Inventors: Seung Seok Lee, Daejeon (KR); Ki Bok Kim, Daejeon (KR); Young Gil Kim, Daejeon (KR); Hyun Jae Shin, Suwon-si (KR); You Hyun Jang, Anyang-si (KR)

(73) Assignees: INDE SYSTEM CO., LTD., Suwon-si, Gyeonggi-do (KR); KOREA RESEARCH INSTITUTE OF STANDARDS AND SCIENCE, Daejeon (KR)

(21) Appl. No.: 13/393,993

(22) PCT Filed: Sep. 1, 2010
(86) PCT No.: PCT/KR2010/005931

§ 371 Date: Apr. 18, 2012

(30) Foreign Application Priority Data
Sep. 3, 2009 (KR) 10-2009-0082929

(51) Int. Cl. G01N 29/00

(52) U.S. Cl. 73/632

(57) ABSTRACT

Multi probe unit for an ultrasonic flaw detection apparatus, includes a plurality of probes contacting a surface of an object to be inspected; a plurality of connection members connecting two neighbor probes of the plurality of probes with each other; support members disposed on top portions of the plurality of probes so as to be spaced apart from the plurality of probes; and a pressing member connecting the plurality of probes with the support member and pressing the plurality of probes to the object to be inspected. According to the present invention, a plurality of probes smoothly contacts a flexural surface of an object to be inspected.

### FIELD OF THE INVENTION

The present invention relates to an ultrasonic flaw detection apparatus, and more particularly, to a multi probe unit for an ultrasonic flaw detection apparatus with an improved structure enabling a plurality of probes generating an ultrasonic wave to smoothly contact a surface of a flexural object to be inspected.

### BACKGROUND OF THE INVENTION

An ultrasonic flaw detection apparatus, which is a kind of a nondestructive inspection apparatus using an ultrasonic wave, is an apparatus for transferring an ultrasonic wave to an object to be inspected to detect discontinuous portions present on a surface of or in an object to be inspected. The ultrasonic wave has a wavelength much shorter than that of audible sound and therefore, has properties such as straightness of light, and may be more easily propagated into a material than an X-ray.

The ultrasonic flaw detection using the ultrasonic flaw detection apparatus measures positions and sizes of defects by comparing energy amount reflected from discontinuous portions of an object to be inspected after transmitting the ultrasonic wave to the object to be inspected, time consumed to transmit the ultrasonic wave to the object to be inspected and return the transmitted ultrasonic wave from the discontinuous portions, difference in an amount of the ultrasonic wave attenuated when the ultrasonic wave transmits the object to be inspected, and the like, with appropriate standard data.

The ultrasonic flaw detection may be widely applied to various fields from materials such as iron, nonferrous metals, and the like, to products such as a ship, a bridge, a pressure vessel, and the like, to parts of an airplane, a car, a railroad car, a machine, and the like. Further, defects that may be detected by the ultrasonic flaw detection apparatus are very wide from unique discontinuity of materials such as cracks, inclusions, lamination, and the like, to discontinuity generated during machining and discontinuity generated during use such as fatigue cracks.

The ultrasonic flaw detection apparatus used for the ultrasonic flaw detection has an ultrasonic probe that transmits the ultrasonic wave to a surface of an object to be inspected and detects the reflected ultrasonic wave.

### SUMMARY OF THE INVENTION

However, the ultrasonic flaw detection apparatus having a single probe can detect absence and presence of detects and positions of defects but cannot accurately detect shapes or sizes of defects. Further, the conventional ultrasonic flaw detection apparatus is difficult to detect an objected having a flexural surface.

The present invention has been made in an effort to provide a multi probe unit for an ultrasonic flaw detection apparatus. The multi probe unit, having a plurality of probes for transmitting an ultrasonic wave, can be in contact with a surface of a flexural object to be inspected. Therefor it enables to improve detection accuracy for a flexural object to be inspected.

According to the present invention, there is provided a multi probe unit for an ultrasonic flaw detection apparatus, including: a plurality of probes contacting a surface of an object to be inspected to project an ultrasonic wave to the object to be inspected; a plurality of connection members connecting two neighbor probes of the plurality of probes with each other, wherein each of the connection members allow the two neighbor probes to change relative positions; a support member disposed over the plurality of probes apart from the plurality of probes; and pressing means connecting the plurality of probes with the support member and pressing the plurality of probes to the object to be inspected.

The elastic force pressing member may include a plurality of elastic members each having one end coupled with the support member, respectively, and the other end coupled with two probes, respectively, wherein the two probes of the plurality of probes are disposed at outermost sides.

The plurality of elastic members may include a first leaf spring having one end coupled with the support member and the other end coupled with one of the two probes disposed at the outermost sides and a second leaf spring having one end coupled with the support member and the other end coupled with the other one of the two probes disposed at the outermost sides.

The pressing means may include a plurality of elastic members each having one end coupled with the support member and the other end coupled with the plurality of probes, respectively.

The elastic member may be selected between the wire spring and the coil spring.

The connection member may include a plurality of plate type links, wherein each of the plate type links has a pair of through holes, and is rotatably coupled with each of the probes by inserting pins joined with each of the probes respectively into the through holes.

The connection member may be a coil spring having one end and the other end coupled with the two neighbor probes, respectively.

The probe may include a flat bottom surface contacting the surface of the object to be inspected and a first lower slope side and a second lower slope side symmetrically provided to each other at left and right sides of the bottom surface thereof, wherein the first lower slope side and the second lower slope side may be tilted so as to be narrow to each other toward the bottom surface thereof.

The probe may include the, flat bottom surface contacting the surface of the object to be inspected and a first upper slope side and a second upper slope side symmetrically provided to each other at the left and right sides of the bottom surface thereof, wherein the first upper slope side and the second upper slope side may be tilted so as to be wide from each other toward the bottom surface thereof.

The multi probe unit for an ultrasonic flaw detection apparatus may further include: a displacement sensor detecting a relative displacement between the plurality of probes, wherein the displacement sensor may include a sensor body fixed to the support member and a mover movably coupled with the sensor body and coupled with any one of the plurality of probes.

### BRIEF DESCRIPTION OF THE DRAWINGS

The above and other objects and features of the present invention will become apparent from the following description of preferred embodiments, given in conjunction with the accompanying drawings.

FIG. 1 is a perspective view showing a multi probe unit for an ultrasonic flaw detection apparatus according to an exemplary embodiment of the present invention;

FIG. 2 is a front view showing the multi probe unit for an ultrasonic flaw detection apparatus according to the exemplary embodiment of the present invention;

FIG. 3 is a side view showing the multi probe unit for an ultrasonic flaw detection apparatus according to the exemplary embodiment of the present invention;

FIG. 4 is an exploded perspective view showing a configuration of a portion of the multi probe unit for an ultrasonic flaw detection apparatus according to an exemplary embodiment of the present invention;

FIGS. 5 and 6 show a state in which the multi probe unit for an ultrasonic flaw detection apparatus according to an exemplary embodiment of the present invention contacts a flexural surface of the object to be inspected;

FIG. 7 is a perspective view showing a multi probe unit for an ultrasonic flaw detection apparatus according to another exemplary embodiment of the present invention;

FIG. 8 is a front view showing a multi probe unit for an ultrasonic flaw detection apparatus according to another exemplary embodiment of the present invention;

FIG. 9 is a side view showing a multi probe unit for an ultrasonic flaw detection apparatus according to another exemplary embodiment of the present invention;

FIG. 10 shows a state in which the multi probe unit for an ultrasonic flaw detection apparatus according to an exemplary embodiment of the present invention contacts a flexural surface of the object to be inspected;

FIG. 11 is a perspective view showing a multi probe unit for an ultrasonic flaw detection apparatus according to another exemplary embodiment of the present invention;

FIG. 12 is a front view showing the multi probe unit for an ultrasonic flaw detection apparatus according to an exemplary embodiment of the present invention;

FIG. 13 is a perspective view showing a multi probe unit for an ultrasonic flaw detection apparatus according to another exemplary embodiment of the present invention; and

FIG. 14 shows a state in which the multi probe unit for an ultrasonic flaw detection apparatus according to an exemplary embodiment of the present invention contacts a flexural surface of the object to be inspected.

### DETAILED DESCRIPTION OF THE PREFERRED EMBODIMENTS

Hereinafter, a multi probe unit for an ultrasonic flaw detection apparatus according to exemplary embodiments of the present invention will be described in detail with reference to the accompanying drawings.

In describing the present invention, the sizes, shapes, or the like of components illustrated in the drawings may be exaggerated or simplified for clarity and convenience. Further, the terminologies specifically defined in consideration of the configuration and functions of the present invention may be construed in different ways by the intention of users and operators. Therefore, the definitions thereof should be construed based on the contents throughout the specification.

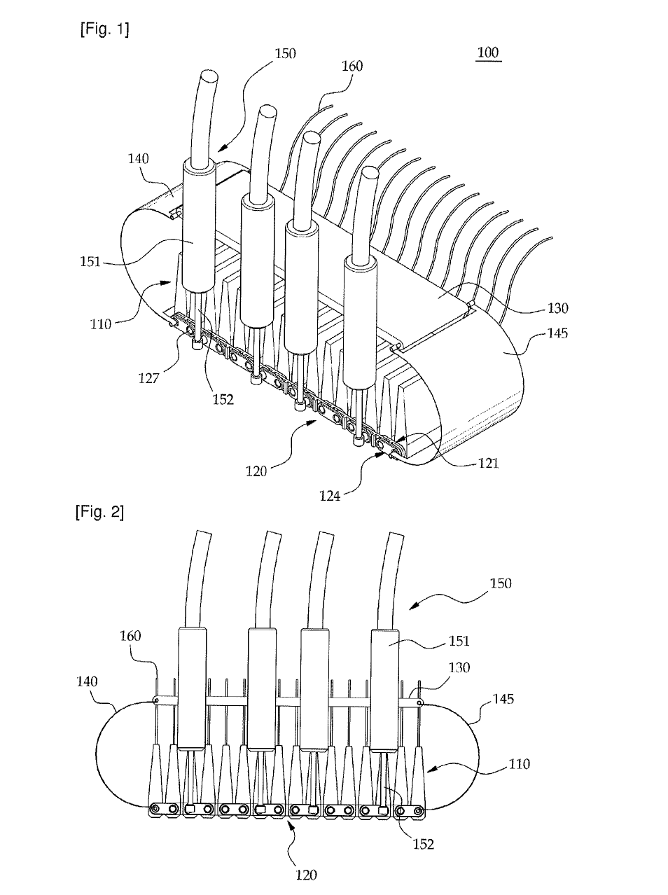

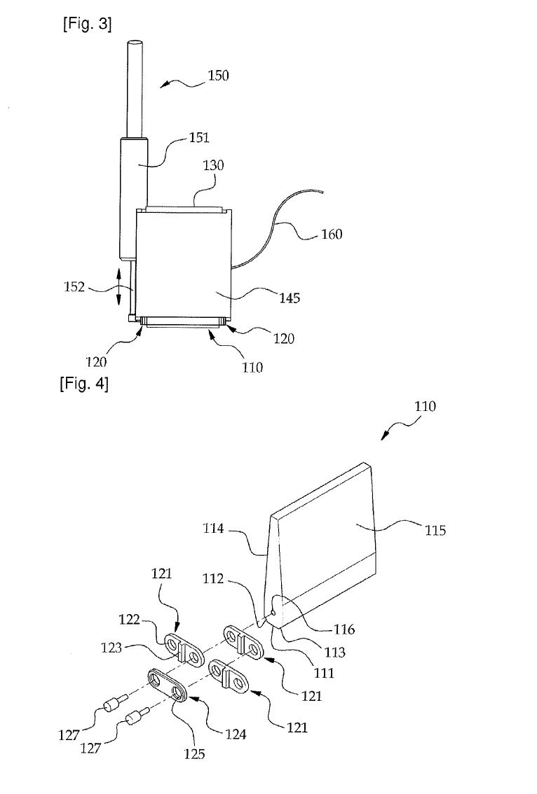

FIG. 1 is a perspective view showing a multi probe unit for an ultrasonic flaw detection apparatus according to an exemplary embodiment of the present invention, FIG. 2 is a front view showing the multi probe unit for an ultrasonic flaw detection apparatus according to the exemplary embodiment of the present invention, and FIG. 3 is a side view showing the multi probe unit for an ultrasonic flaw detection apparatus according to the exemplary embodiment of the present invention.

As shown in FIGS. 1 to 3, a multi probe unit 100 for an ultrasonic flaw detection apparatus according to an exemplary embodiment of the present invention is configured to include a plurality of probes 110 that project an ultrasonic wave to an object to be inspected, a connection chain 120 that connects the plurality of probes 110 with one another, a support member 130 and a pair of leaf springs 140 and 145 that support the plurality of probes 110, and a plurality of displacement sensors 150 that detects a relative displacement of the plurality of probes 110. The plurality of probes 110 are connected with a central processing unit of the ultrasonic flaw detection apparatus by signal lines 160.

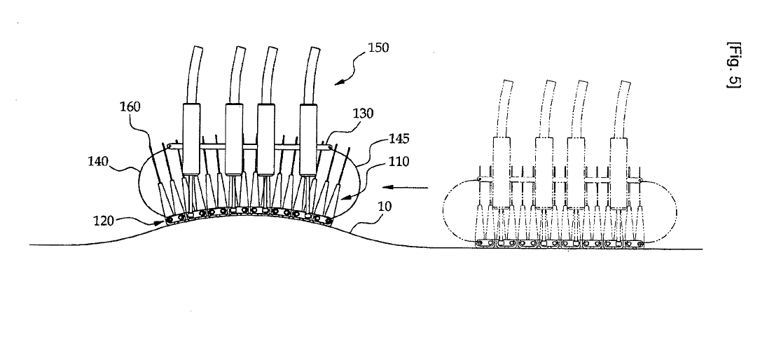

As shown in FIG. 4, the probe 110 is configured to include flat bottom surfaces 111 thereof that contact a surface of an object to be inspected, a first lower slope side 112 and a second lower slope surface 113 that are symmetrically disposed to each other at left and right sides of the bottom surfaces 111 thereof, and a first upper slope side 114 and a second upper slope side 115 that are symmetrically disposed to each other on the first lower slope side 112 and the second lower slope side 113. The first lower sloe side 112 and the second lower slop side 113 are tilted to be narrow from top toward bottom and the first upper slope side 114 and the second upper slope side 115 are tilted so as to be wide from top toward bottom.

Therefore, the probe 110 is formed to have a narrow width from top ends of the first lower slope side 112 and the second lower slope side 113 toward the bottom surfaces 111 thereof and a narrow width from bottom ends of the first upper slope side 114 and the second upper slope side 115 toward top ends thereof. By this configuration, when the plurality of probes 110 connected with one another in a line by the connection chain 120 are tilted, it is possible to prevent neighbor probes from bumping against each other. A detailed movement of the plurality of probes 110 will be described below. Front and back surfaces of the probe 110 are provided with coupling holes 116.

The connection chain 120, which is to connect the plurality of probes 110 with one another in a line, includes a plurality of first links 121 and a plurality of second links 124. As shown in FIG. 4, the first link, which is a plate type link, has a protruding part 123 that is disposed to be protruded to one side between a pair of through holes 1221. The second link 124, which is a plate type link, has a pair of through holes 125. Some of the plurality of first links 121 connect two neighbor probes 110 with each other and the remaining thereof are connected with the probes 110 to connect two neighbor first links 121 with each other. The second links 124 are coupled with the probe 110 to connect the two neighbor first links 121 with each other.

These links 121 and 124 are coupled with the probes 110 while being connected with each other by coupling pins 127 that are coupled with the probes 110. The coupling pins 127 penetrate through each through hole 122 and 125 of the first links 121 and the second links 124 and ends thereof are inserted into the coupling holes 116 of the probes 110 so as to be coupled with the probes 110. A section shape of the coupling pins 127 and the through holes 122 and 125 of the first links 121 and the second links 124 are a circle, such that the first links 121 and the second links 124 coupled with the coupling pins 127 may rotate.

Therefore, the plurality of probes 110 connected with one another by the connection chain 120 may rotate by a predetermined angle based on the coupling pins 127 while maintaining a state in which the plurality of probes are connected with one another in a line, and a vertical displacement may occur between the plurality of probes 110. The coupling pins 127 may be integrally disposed with the probes 110 so as to be protruded from the probes 110.

As shown in FIGS. 1 and 2, the support member 130 is disposed on the top portions of the plurality of probes 110 so as to be spaced apart from the top ends of the plurality of probes 110 and is connected with the plurality of probes 110 by the pair of leaf springs 140 and 145. One end of the first leaf spring 140 is coupled with one end of the support member 130 and the other end thereof is coupled with the coupling pin 127 of any one of the two probes 110 that are disposed at an outermost side. One end of the second leaf spring 145 is coupled with the other end of the support member 130 and the other end thereof is coupled with the coupling pin 127 of the other one of the two probes 110 that are disposed at an outermost side.

The first leaf spring 140 and the second leaf spring 145 apply elastic force to the two probes 110 that are disposed at an outermost side. The plurality of probes 110 are connected with one another by the connection chain 120 and therefore, the plurality of probes 110 are applied with elastic force from the first plate spring 140 and the second plate spring 145. Therefore, the plurality of probes 110 may be constantly spaced apart from the support member 130 and smoothly contact the object to be inspected when being put on the object to be inspected.

In addition, the connection chain 120 and the plurality of probes 110 may maintain a state unfolded in a line rather than being folded, by an action of the first leaf spring 140 and the second leaf spring 145. The first leaf spring 140 and the second leaf spring 145 may be changed into another type of elastic member one end coupled with the support member 130 and the other end is coupled with the probes 110 that are disposed at the outermost side to apply elastic force to the plurality of probes 110 in a direction of the object to be inspected and in a direction unfolded from each other.

As shown in FIGS. 1 to 3, the displacement sensor 150 is configured to include a sensor body 151 that is fixed to the support member 130 and a mover 152 that is movably coupled with the sensor body 151. The sensor body 151 is fixed to the support member 130 by various methods, such as welding, adhesives, and the like. An end of the mover 152 is coupled with the coupling pin 127 of the probe 110. The mover 152 may be coupled with the coupling pin 127 by various methods such as welding, adhesive, and the like.

The displacement sensor 150 generates a displacement signal when a mounting height of the probe 110 is varied. That is, when a gap between the probes 110 and the support member 130 is small or large, the mover 152 of the displacement sensor 150 more enters into the sensor body 151 or a predetermined portion thereof exits from the sensor body 151. As such, the displacement signal is generated by the movement of the mover 152. The displacement sensor 150 transmits the generated signal to the central processing unit of the ultrasonic flaw detection apparatus.

The mounting number of the displacement sensor 150 is limited to the aforementioned example but may be variously changed. As the displacement sensor 150, various sensors coupled with the probe 110, such as a linear encoder, an electromagnetic displacement sensor, a potentiometer, and the like, to detect a relatively vertical displacement of the probe 110 can be used.

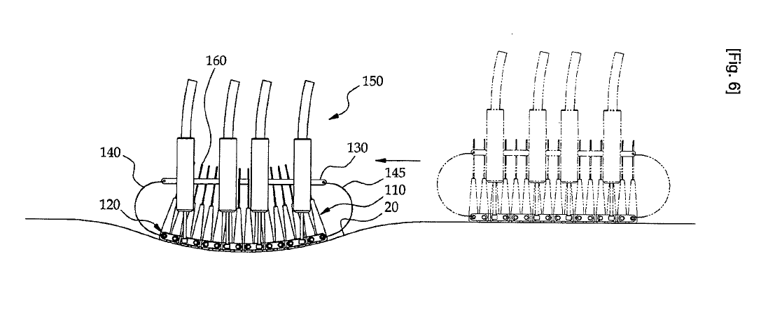

FIGS. 5 and 6 show a process of using the multi probe unit 100 according to the exemplary embodiment of the present invention to detect the object to be inspected having a flexural surface. First, as shown in FIG. 5, when the multi probe unit 100 moves along the surface of the object to be inspected having a protruded flexural surface 10, the plurality of probes 110 are tilted while maintaining a constant pitch or the bottom surfaces 111 thereof are disposed in parallel with the tangential, direction of the flexural surface 10 while the relative mounting height thereof is varied. In this case, the first leaf spring 140 and the second leaf spring 145 apply the elastic force to the plurality of probes 110 downwardly and each bottom surface 111 of the plurality of probes 110 may smoothly contact the flexural surface 10.

When the multi probe unit 100 moves along the protruded flexural surface 10, each of the bottom ends of the plurality of probes 110 approaches one another while the plurality of probes 110 are tilted. In this case, the probe 110 is formed to have a narrow width from the top ends of the first lower slope side 112 and the second lower slope side 113 toward the bottom surfaces 111 thereof, such that it is possible to prevent neighbor probes 110 from bumping against each other. Further, when each bottom surface 111 of the plurality of probes 110 contacts the flexural surface 10, the probes 110 disposed at a central side thereof rise upwardly and the probes 110 disposed at an outer side thereof are disposed under the center thereof. As such, when the mounting height of the probe 110 is varied, the displacement sensor 150 connected with the probe 110 of which the displacement is generated is operated to generate the displacement signal.

As shown in FIG. 6, when the multi probe unit 100 moves along the surface of the object to be inspected having a depressed flexural surface 20, the plurality of probes 110 are tilted or each bottom surface 111 thereof contacts the flexural surface 20 while the relative mounting height thereof is varied. In this case, the first leaf spring 140 and the second leaf spring 145 press the plurality of probes 110 downwardly and each bottom surface 111 of the plurality of probes 110 may smoothly contact the depressed flexural surface 20.

When the multi probe unit 100 moves along the depressed flexural surface 20, each of the top ends of the plurality of probes 110 is tilted to approach one another. In this case, the probe 110 is formed to have a narrow width from the bottom ends of the first upper slope side 114 and the second upper slope side 115 toward the top ends thereof, such that the neighbor probes 110 can be smoothly tilted without bumping against each other. Further, when each bottom surface 111 of the plurality of probes 110 contact the flexural surface 20, the probe 110 that is disposed at the outside thereof is disposed above the center thereof. As such, when the mounting height of the probe 110 is varied, the displacement sensor 150 connected with the probe 110 of which the displacement is generated is operated to generate the displacement signal.

As such, the multi probe unit 100 according to the exemplary embodiment of the present invention contacts the flat surface of the object to be inspected and contacts the protruded flexural surface 10 or the depressed flexural surface 20 of the object to be inspected, thereby smoothly projecting the ultrasonic wave through the surface of the object to be inspected.

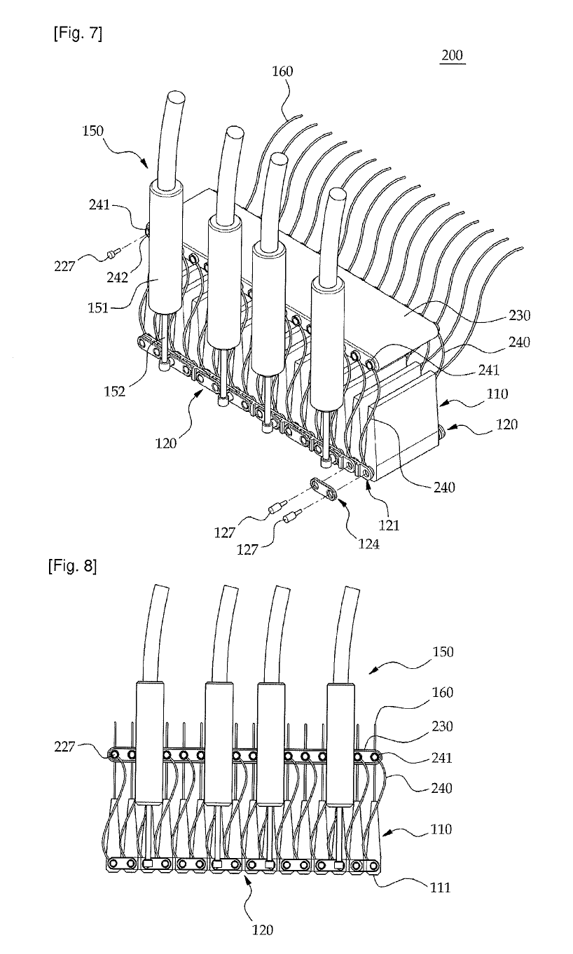

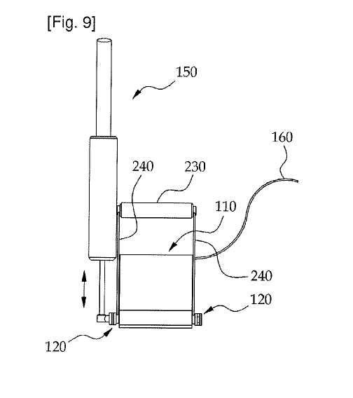

FIGS. 7 to 9 show a multi probe unit for an ultrasonic flaw detection apparatus according to another exemplary embodiment of the present invention.

As shown in FIGS. 7 to 9, a multi probe unit 200 for an ultrasonic flaw detection apparatus according to another exemplary embodiment of the present invention is configured to include a plurality of probes 110 that project an ultrasonic wave to an object to be inspected, a connection chain 120 that connects the plurality of probes 110 with one another, a support member 230 and a plurality of wire springs 240 that support the plurality of probes 110, and a plurality of displacement sensors 150 that detects a relative displacement of the plurality of probes 110.

In this configuration, the probe 110, the connection chain 120, and the displacement sensor 150 are the same as components of the multi probe unit 100 according to the embodiment of the present invention. Although not explicitly shown in the drawings, the sensor body 151 of the displacement sensor 150 may be fixed to the support member 230 by various methods such as using a separate fixing member, and the like. Hereinafter, the same components as the aforementioned components are denoted by the same reference numerals and the detailed description thereof will be omitted.

The plurality of wire springs 240 are coupled with the plurality of probes 110 by a pair. The plurality of wire springs 240, which serve as the first leaf spring 140 and the second leaf spring 145 of the aforementioned multi probe unit 100, applies elastic force to the plurality of probes 110 in a direction of the object to be inspected and a direction unfolded from each other. The top end of the wire spring 240 is coupled with the support member 230 and the bottom end thereof is coupled with the probe 110. The top end and the bottom end of the wire spring 240 are provided with a hollow connection ring 241.

The connection ring 241 that is disposed at the bottom end of the wire spring 240 is coupled with the probe 110 by the coupling pin 127, together with the links 121 and 124 and the connection ring 241 that is disposed at the top end of the wire spring 240 is coupled with the support member 230 by a spring coupling pin 227 that is coupled with the support member 230. A shape of a through hole 242 of the connection ring 241, a section shape of the coupling pin 127, and a section shape of the spring coupling pin 227 are a circle, such that the wire spring 240 may be rotatably coupled with the coupling pin 127 and the spring coupling pin 227.

The front and back ends of the support member 230 is provided with a coupling hole into which the spring coupling pin 227 is inserted. The spring coupling pin 227 may be integrally disposed with the support member 230. The plurality of wire springs 240 may be coupled with the support member 230 and the probes 110 by various methods in addition to coupling structures such as the pair of connection rings 241, the coupling pin 127, and the spring coupling pin 227. In addition, the plurality of wire springs 240 may be changed into another type of elastic member having one end coupled with the support member 230 and the other end coupled with the probes 110 to apply elastic force to the probes 110 in a direction of the object to be inspected and a direction unfolded from each other. For example, a coil spring may replace the wire spring 240.

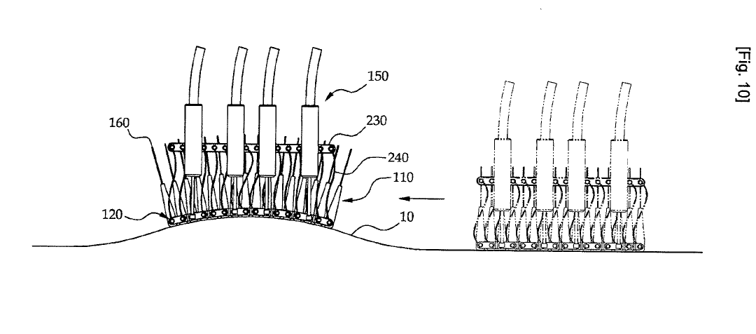

As such, the multi probe unit 200 according to another exemplary embodiment of the present invention can smoothly contact the flat surface and the protruded flexural surface 10 of the object to be inspected, as shown in FIG. 10. When the multi probe unit 200 is disposed on the depressed flexural surface 10, the plurality of probes 110 is tilted or each bottom surface 111 is disposed in parallel with a tangential direction with respect to the flexural surface 10 while the relative mounting height thereof is varied. In this case, the plurality of wire springs 240 presses the plurality of probes 110 to the object to be inspected, such that the plurality of probes 110 can smoothly contact each bottom surface 111 to the flexural surface 10. The multi probe unit 200 according to another exemplary embodiment of the present invention may smoothly contact the depressed flexural surface.

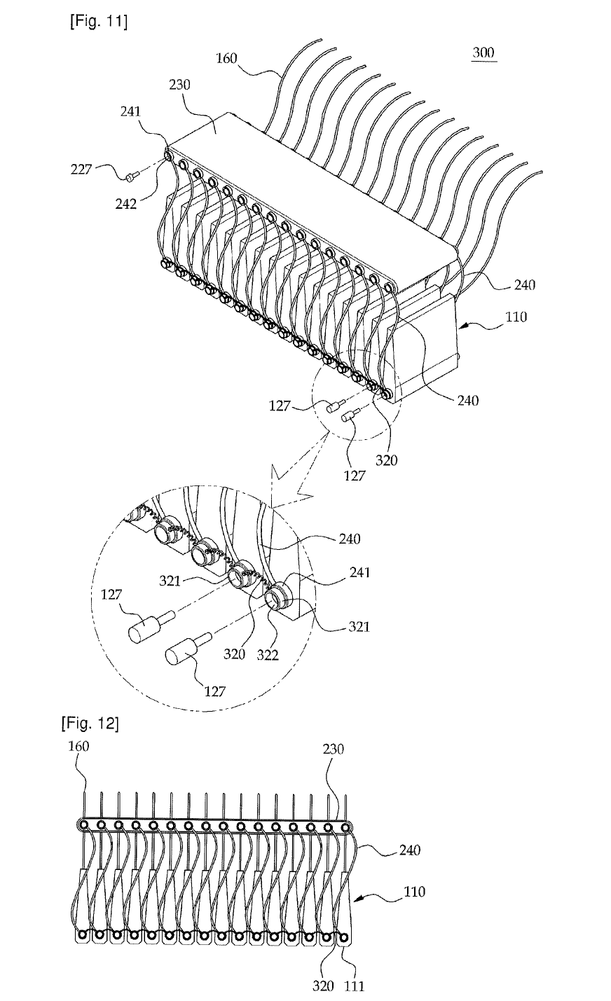

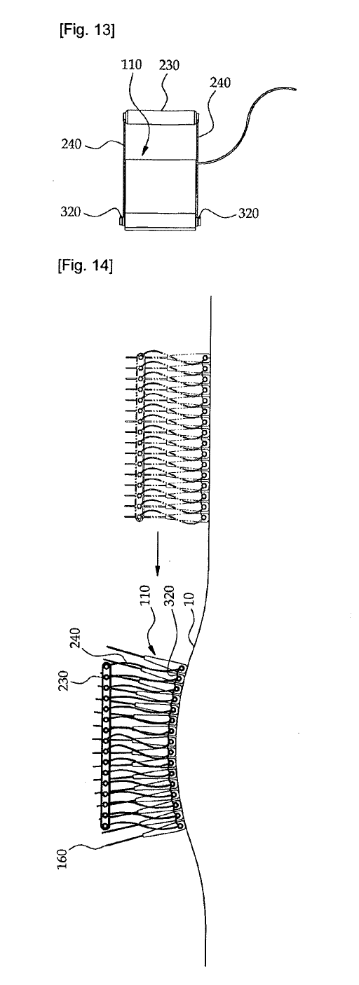

FIGS. 11 to 13 show a multi probe unit for an ultrasonic flaw detection apparatus according to another exemplary embodiment of the present invention.

As shown in FIGS. 11 to 13, a multi probe unit 300 for an ultrasonic flaw detection apparatus according to another exemplary embodiment of the present invention is configured to include a plurality of probes 110 that project an ultrasonic wave to an object to be inspected, a plurality of coil springs 320 that connect the plurality of probes 110 with one another, and a support member 230 and a plurality of wire springs 240 that support the plurality of probes 110.

In this configuration, the probe 110, the support member 230, and the plurality of wire springs 240 are the same as components of the multi probe unit 200 according to another embodiment of the present invention. The multi probe unit 300 according to another exemplary embodiment of the present invention may include the plurality of displacement sensors 150 that detect the relative displacement of the plurality of probes 110 like the aforementioned multi probe unit 200. Hereinafter, the same components as the aforementioned components are denoted by the same reference numerals and the detailed description thereof will be omitted.

The plurality of coil springs 320, which are to connect the plurality of probes 110 with one another in a line, serve as the plurality of first links 121 and the second links 124 of the aforementioned multi probe units 100 and 200. The single coil spring 320 is coupled with a pair of connection rings 321 that is coupled with the two neighbor probes 110, respectively. The connection ring 321 has a hollow shape of which the center is provided with a through hole 322. The connection ring 321 is coupled with the probe 110 by the coupling pin 127 coupled with the probe 110, together with the hollow type connection ring 241 disposed at the bottom end of the wire spring 240. The shape of the through hole 322 of the connection ring 321 is a circle like the section shape of the coupling pin 120, such that the connection ring 321 may be rotatably coupled with the coupling pin 127.

The coil spring 320 is coupled with the connection ring 321, such that all the probes 110 are connected with each other in a line by the plurality of coil springs 320. As such, the plurality of coil springs 320 that connects the plurality of probes 110 with one another may be flexurally deformed, such that the plurality of probes 110 are tilted or the relative mounting height thereof may be varied.

Therefore, as shown in FIG. 14, when the multi probe unit 300 is disposed on the protruded flexural surface 10 of the object to be inspected, each bottom surface 111 of the plurality of probes 110 is disposed in parallel with the tangential direction of the flexural surface 10 so as to smoothly contact the flexural surface 10 while the plurality of coil springs 320 are flexurally deformed.

As described above, in the multi probe units 100, 200, and 300 according to the exemplary embodiments of the present invention, there is shown that the plurality of probes 110 are connected with one another by the plurality of links 121 and 124 or the coil spring 320. However, in the exemplary embodiments of the present invention, the plurality of probes 110 may be connected with one another in a line by various connection members in addition to the links 121 and 124 or the coil spring 320. In addition, the pair of leaf springs 140 and 145 or the plurality of wire springs 240 shown and described may be changed into another type of pressing member that is supported to the support member 230 to press the plurality of probes 100 in a direction of the objected to be inspected and a direction unfolded from each other.

In the multi probe unit for an ultrasonic flaw detection apparatus according to the exemplary embodiments of the present invention, the plurality of probes generating an ultrasonic wave can be connected with one another in a line by the connection member, but the plurality of probes can be tilted or the relative mounting height of the plurality of probes can be varied. Therefore, the arrangement structure of the plurality of probes can be easily changed according to the shape of the surface of the objected to be inspected to smoothly contact the surface of the flat object to be inspected and the surface of the object to be inspected.

Further, in the multi probe unit for an ultrasonic flaw detection apparatus according to the exemplary embodiments of the present invention, the plurality of probes can be pressed to the objet to be inspected by the pressure member, such that the bottom surfaces of the probes can smoothly contact the surface of the flexural object to be inspected.

In addition, in the multi probe unit of an ultrasonic flaw detection apparatus of the exemplary embodiments of the present invention, the bottom surfaces of the probes can contact the surface of the object to be inspected in parallel with a tangential direction, thereby smoothly transmitting the ultrasonic wave into the object to be inspected and improving the detection accuracy for the object to be inspected.

According to the exemplary embodiments of the present invention, the multi probe unit for an ultrasonic flaw detection apparatus can be used to detect damages or defects of various flexural objects to be inspected such as parts for a ship, a bridge, a pressure vessel, an airplane, a car, a railroad car, and the like, parts of machinery, and the like.

The exemplary embodiment of the present invention, which is described as above and shown in the drawings, should not be interpreted as limiting the technical spirit of the present invention. The scope of the present invention is limited only by matters set forth in the claims and those skilled in the art can modify and change the technical subjects of the present invention in various forms. Therefore, as long as these improvements and changes are apparent to those skilled in the art, they are included in the protective scope of the present invention.

What is claimed is:

1. A multi probe unit for an ultrasonic flaw detection apparatus, comprising:
a plurality of probes contacting a surface of an object to be inspected to project an ultrasonic wave to the object to be inspected;
a plurality of connection members connecting two neighbor probes of the plurality of probes with each other, wherein each of the connection members allow the two neighbor probes to change relative positions;
a support member disposed over the plurality of probes apart from the plurality of probes; and
pressing means connecting the plurality of probes with the support member and pressing the plurality of probes to the object to be inspected.

2. The multi probe unit for an ultrasonic flaw detection apparatus of claim 1, wherein the pressing means includes a plurality of elastic members each having one end coupled with the support member, respectively, and the other end coupled with two probes, respectively, wherein the two probes of the plurality of probes are disposed at outermost sides.

3. The multi probe unit for an ultrasonic flaw detection apparatus of claim 2, wherein the plurality of elastic members includes a first leaf spring having one end coupled with the support member and the other end coupled with one of the two probes disposed at the outermost sides and a second leaf spring having one end coupled with the support member and the other end coupled with the other one of the two probes disposed at the outermost sides.

4. The multi probe unit for an ultrasonic flaw detection apparatus of claim 1, wherein the pressing means includes a plurality of elastic members each having one end coupled with the support member and the other end coupled with the plurality of probes, respectively.

5. The multi probe unit for an ultrasonic flaw detection apparatus of claim 4, wherein the elastic member is selected between a wire spring and a coil spring.

6. The multi probe unit for an ultrasonic flaw detection apparatus of claim 1, wherein the connection member includes a plurality of plate type links, wherein each of the plate type links has a pair of through holes, and is rotatably coupled with each of the probes by inserting pins joined with each of the probes respectively into the through holes.

7. The multi probe unit for an ultrasonic flaw detection apparatus of claim 1, wherein the connection member is a coil spring having two ends of the coil spring coupled with the two neighbor probes, respectively.

8. The multi probe unit for an ultrasonic flaw detection apparatus of claim 1, wherein the probe includes a flat bottom surface contacting the surface of the object to be inspected and a first lower slope side and a second lower slope side symmetrically provided to each other at left and right sides of the bottom surface thereof, the first lower slope side and the second lower slope side being tilted so as to be narrow to each other toward the bottom surface thereof.

9. The multi probe unit for an ultrasonic flaw detection apparatus of claim 1, wherein the probe includes the flat bottom surface contacting the surface of the object to be inspected and a first upper slope side and a second upper slope side symmetrically provided to each other at the left and right sides of the bottom surface thereof, the first upper slope side and the second upper slope side being tilted so as to be wide from each other toward the bottom surface thereof.

10. The multi probe unit for an ultrasonic flaw detection apparatus of claim 1, further comprising: a displacement sensor detecting a relative displacement between the plurality of probes,
wherein the displacement sensor includes a sensor body fixed to the support member and a mover movably coupled with the sensor body and coupled with any one of the plurality of probes.
